(19) United States
(12) Patent Application Publication
(10) Pub. No.: US 2006/0069225 A1
(43) Pub. Date: Mar. 30, 2006

(54) Adhesive compositions containing blocked polyurethane prepolymers

(76) Inventors: Matthias Wintermantel, Koln (DE); Christoph Gurtler, Koln (DE); Michael Schelhaas, Koln (DE); Rainer Trinks, Dormagen (DE); Walter Meckel, Dusseldorf (DE)

Correspondence Address: BAYER MATERIAL SCIENCE LLC, 100 BAYER ROAD, PITTSBURGH, PA, 15205, US

(21) Appl. No.: 11/219,396

(22) Filed: Sep. 2, 2005

(30) Foreign Application Priority Data
Sep. 8, 2004 (DE) 102004043342.9

(51) Int. Cl. C08G 18/00

(52) U.S. Cl. 528/44

(57) ABSTRACT

The present invention relates to reactive compositions containing A) one or more blocked polyurethane prepolymers which have a content of blocked isocyanate groups (calculated as NCO) of 0.1 to 20 wt. % and are prepared from i) at least one aromatic, aliphatic, araliphatic and/or cycloaliphatic diisocyanate having a content of free NCO groups of 5 to 60 wt. %, ii) a polyol component containing at least one polyester polyol, and/or at least one polyether polyol and/or at least one polycarbonate polyol,
iii) CH-acidic cyclic ketones corresponding to formula (I) as blocking agents 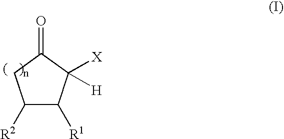 wherein X represents an electron-attracting group,
R¹ and R² independently of one another represent the radicals H,
C₁-C₂₀ (cyclo)alkyl, C₆-C₂₄ aryl, C₁-C₂₀ (cyclo)alkyl ester or amide, C₆-C₂₄ aryl ester or amide, mixed aliphatic/aromatic radicals with 1 to 24 carbon atoms that can also be part of a 4- to 8-membered ring, n is an integer from 0 to 5, and B) one or more OH-functional compounds in which the OH component undergoes activation by a deposition amine component. The present invention also relates to a composite system containing two adherends bonded together with the reactive composition according to the invention.

### BACKGROUND OF THE INVENTION

1. Field of the Invention

The invention relates to novel reactive compositions based on blocked polyurethane prepolymers, a process for the production thereof and their use in adhesive compositions.

2. Description of Related Art

The blocking of polyisocyanates or polyurethane prepolymers for the temporary protection of the isocyanate groups is a known working method and is described e.g. in Houben Weyl, Methoden der organischen Chemie XIV/2, pp. 61-70. An overview of blocking agents that are suitable in principle can be found e.g. in Wicks et al., Progress in Organic Coatings 1975, 3, pp. 73-79, 1981, 9, pp. 3-28 and 1999, 36, pp. 148-172. Curable compositions containing blocked polyisocyanates or polyurethane prepolymers are used e.g. in polyurethane (PUR) lacquers or polyurethane (PUR) adhesives.

Thus, DE-A 199 63 585 describes a hot melt adhesive composition containing a prepolymer having isocyanate groups, obtained by reacting at least partly crystalline, linear polyesters in admixture with linear polyethers and optionally amorphous polyesters with diisocyanates, the reactive isocyanate groups being partly or completely blocked with known blocking agents, and diamines and/or their epoxy adducts as the crosslinking agent component.

In EP-A 0 419 928, one-pack polyurethane adhesives with a long shelf life are described, which are at least partly crystalline at room temperature, predominantly linear and curable under the effect of heat. They are based on a polyurethane prepolymer that is at least partly crystalline, contains isocyanate groups capped with monofunctional blocking agents known from polyurethane chemistry and at least one low molecular-weight, NH— and/or OH-functional chain-extending or crosslinking agent.

Blocked isocyanates are also described in U.S. Pat. No. 4,798,879 as components of an adhesive system. A two-component system that sets rapidly at room temperature is described there, consisting of a prepolymer containing blocked isocyanate groups and primary amines as hardeners.

In the preceding adhesive compositions, the blocking agent performs the following tasks: 1) it prevents the NCO groups from reacting prematurely with the NH and/or OH crosslinking agent component, and 2) it regulates the curing of the adhesives in a particular temperature range by its specific unblocking property. In addition, an increased shelf life of the adhesive compositions results, since an undesirable side reaction with traces of water that get into the adhesives during production or storage and lead to an increase in viscosity, and ultimately to curing before processing, is prevented.

In addition to these desired properties, however, the individual blocking agents also bring disadvantages, such as a lack of cost-effectiveness, environmental problems and critical physiological effects.

Volatile organic compounds are released by the separation of the blocking agent. These generally remain in the adhesive layer and act as plasticizers, exerting a disadvantageous effect on the application property profile of the adhesive formulation. Also, the separation of the blocking agent is an equilibrium reaction. Since the separated blocking agent remains in the glueline, the unblocking does not run to completion, which leads to incomplete crosslinking of the adhesive. This also causes significant impairment of the application property profile of the adhesive. If, however, the separated blocking agents leave the adhesive layer, their gaseous escape can lead to the formation of bubbles in the adhesive layer and thus also to reduced strength of the bonded joint.

In WO-A 03/004545, emission-free blocked organic polyisocyanates and polyisocyanate prepolymers are disclosed, in which special CH-acidic cyclic ketones are used as blocking agents. The crosslinking of the blocked isocyanates takes place without separation, i.e. release of the blocking agent, with polyols at temperatures in the range of 110° C. to 140° C. within 15 to 30 minutes or at temperatures of 300° C. to 400° C. within 2 minutes. Furthermore, it is mentioned that the polyisocyanates blocked according to the invention can also be cured with di- or polyamines. This reaction should preferably be performed at room temperature. The reaction conditions mentioned above prevent this system from being widely used as an adhesive, however, since many substrates are irreversibly damaged at temperatures of 110 to 130° C. over a period of 15 to 30 minutes. In addition, these crosslinking conditions are also often unsuitable from an economic point of view (energy costs).

DE-A 102 60 300 discloses crosslinking agents for powder coatings based on emission-free blocked polyurethane crosslinking agents. The blocking again takes place with special CH-acidic cyclic ketones. The curing takes place with known curing agents for powder coatings at temperatures between 110° C. and 220° C. over a period of 1 to 6 minutes. Here again, the crosslinking conditions are prohibitive for use as an adhesive for the reasons already mentioned.

DE-A 102 60 299 describes polyurethane prepolymers blocked with special CH-acidic cyclic ketones, which cure with no emissions and are based on polyethers, and reactive compositions produced therefrom which cure at room temperature, and their use for the production of adhesives, sealants, mouldings and coatings. The curing of the blocked prepolymers takes place with polyamines having a molecular weight of between 60 and 500 g/mol or with polyether amines, which are marketed e.g. by Huntsman under the trade name Jeffamine®. The curing of these systems takes place at room temperature within a few minutes to hours. It is a two-component system, which has only a very limited processing time (pot life) because of the short curing time. This can lead to processing problems, e.g. when bonding large-area substrates.

An object of the present invention is to provide a reactive composition based on blocked polyurethane (PUR) prepolymers as adhesive formulations, which react without emissions, i.e. without the separation of a blocking agent, have a good shelf life at ambient temperature, crosslink at low temperatures and at the same time exhibit a sufficiently long pot life or processing time.

This object may be achieved with the reactive compositions based on PUR prepolymers according to the invention, which are blocked with special CH-acidic compounds and are highly suitable as crosslinking agent components for thermally activated adhesive compositions. These specially blocked polyisocyanate prepolymers can be combined with OH-functional reactants in which the OH component undergoes activation by a β-position amine component and cure without the separation of volatile substances over several hours at room temperature or within minutes to hours at temperatures of between 50° C. and 90° C.

### SUMMARY OF THE INVENTION

The present invention relates to reactive compositions containing
A) one or more blocked polyurethane prepolymers which have a content of blocked isocyanate groups (calculated as NCO) of 0.1 to 20 wt. % and are prepared from
   i) at least one aromatic, aliphatic, araliphatic and/or cycloaliphatic diisocyanate having a content of free NCO groups of 5 to 60 wt. %,
   ii) a polyol component containing at least one polyester polyol, and/or at least one polyether polyol and/or at least one polycarbonate polyol,
   iii) CH-acidic cyclic ketones corresponding to formula (I) as blocking agents 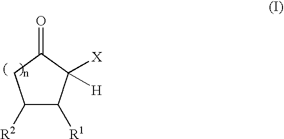
      wherein
      X represents an electron-attracting group,
      R¹ and R² independently of one another represent the radicals H, C₁-C₂₀ (cyclo)alkyl, C₆-C₂₄ aryl, C₁-C₂₀ (cyclo)alkyl ester or amide, C₆-C₂₄ aryl ester or amide, mixed aliphatic/aromatic radicals with 1 to 24 carbon atoms that can also be part of a 4- to 8-membered ring,
      n is an integer from 0 to 5, and
B) one or more OH-functional compounds in which the OH component undergoes activation by a β-position amine component,
C) optionally catalysts and
D) optionally additives and/or auxiliaries.

The present invention also relates to a composite system containing two adherends bonded together with the reactive composition according to the invention.

### DETAILED DESCRIPTION OF THE INVENTION

Diisocyanates suitable as component i) for the production of blocked polyurethane prepolymers A) are those having isocyanate contents of 5 to 60 wt. % (based on the diisocyanate) and having aliphatically, cycloaliphatically, araliphatically and/or aromatically bound isocyanate groups. Examples include 1,4-diisocyanatobutane, 1,6-diisocyanatohexane (HDI), 2-methyl-1,5-diisocyanato-pentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclo-hexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanatomethyl-cyclohexane, bis(isocyanatomethyl)norbornane, 1,3- and 1,4-bis(2-isocyanato-prop-2-yl)benzene (TMXDI), 2,4- and/or 2,6-diisocyanatotoluene (TDI), 2,2′-, 2,4′- and/or 4,4′-diisocyanatodiphenylmethane (MDI), 1,5-diisocyanato-naphthalene or 1,3- and 1,4-bis(isocyanatomethyl)benzene. Preferred diisocyanates are 1,6-diisocyanatohexane (HDI), 1-isocyanato-3,3,5-trimethyl-5-isocyanatomethylcyclohexane (isophorone diisocyanate, IPDI), 4,4′-diisocyanatodicyclohexylmethane, 2,4- and/or 2,6-diisocyanatotoluene (TDI) and 2,2′-, 2,4′- and/or 4,4′-diisocyanatodiphenylmethane (MDI).

Suitable starting components i) also include polyisocyanate adducts, which are prepared from the preceding diisocyanates and have uretdione, isocyanurate, iminooxadiazine dione, urethane, allophanate, acylurea, biuret and/or oxadiazine trione groups. Examples are described e.g. in J. Prakt. Chem. 336 (1994) 185-200 or DE-A 16 70 666, DE-A 19 54 093, DE-A 24 14 413, DE-A 24 52 532, DE-A 26 41 380, DE-A 37 00 209, DE-A 39 00 053, DE-A 39 28 503, EP-A 336 205, EP-A 339 396 and EP-A 798 299.

Polyols suitable as components ii) for the production of the blocked polyurethane prepolymers include the polyester polyols, polyether polyols and/or polycarbonate polyols that are known from polyurethane chemistry.

Polyester polyols having a number average molecular weight of about 200 to about 10 000 g/mol, preferably of about 1000 to about 6000 g/mol, are suitable as polyol component ii). The polyester polyols may be formed by the reaction of low molecular-weight alcohols, particularly ethylene glycol, diethylene glycol, neopentyl glycol, hexanediol, butanediol, propylene glycol, glycerol or trimethylolpropane, with caprolactone. Also suitable as polyfunctional alcohols for the production of polyester polyols are 1,4-hydroxymethylcyclohexane, 2-methyl-1,3-propanediol, 1,2,4-butanetriol, triethylene glycol, tetraethylene glycol, polyethylene glycol, dipropylene glycol, polypropylene glycol, dibutylene glycol and polybutylene glycol.

Other suitable polyester polyols can be produced by polycondensation. Difunctional and/or trifunctional alcohols can be reacted with a deficiency of dicarboxylic acids and/or tricarboxylic acids, or the reactive derivatives thereof, in a condensation reaction to form polyester polyols. Suitable dicarboxylic acids include adipic acid or succinic acid and their higher homologs with up to 16 C atoms; unsaturated dicarboxylic acids such as maleic acid or fumaric acid; and aromatic dicarboxylic acids, particularly the isomeric phthalic acids, such as phthalic acid, isophthalic acid or terephthalic acid. Suitable as tricarboxylic acids include citric acid or trimellitic acid. The above-mentioned acids can be used individually or as mixtures of two or more. Particularly suitable alcohols include hexanediol, butanediol, ethylene glycol, diethylene glycol, neopentyl glycol, 3-hydroxy-2,2-dimethylpropyl-3-hydroxy-2,2-dimethylpropanoate, tmmethylol-propane or mixtures of two or more of these alcohols. Particularly suitable acids are phthalic acid, isophthalic acid, terephthalic acid, adipic acid or dodecanedioic acid or mixtures thereof.

Polyester polyols having a high molecular weight include the reaction products of polyfunctional, preferably difunctional, alcohols (optionally together with small quantities of trifunctional alcohols) and polyfunctional, preferably difunctional, carboxylic acids. Instead of free polycarboxylic acids, the corresponding polycarboxylic anhydrides or corresponding polycarboxylic acid esters with alcohols having preferably 1 to 3 C atoms can also be used. The polycarboxylic acids can be aliphatic, cycloaliphatic, aromatic or heterocyclic, or both. They may optionally be substituted, e.g. by alkyl groups, alkenyl groups, ether groups or halogens. Suitable as polycarboxylic acids include succinic acid, adipic acid, suberic acid, azelaic acid, sebacic acid, dodecanedioic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid or trimer fatty acid or mixtures thereof.

Polyesters obtainable from lactones, e.g. based on ε-caprolactone, also known as “polycaprolactones”, or hydroxycarboxylic acids, e.g. ω-hydroxycaproic acid, can also be used.

Polyester polyols of oleochemical origin can also be employed. For example, these polyols can be produced by complete ring-opening of epoxidized triglycerides of an at least partly olefinically unsaturated, fatty acid-containing fat mixture with one or more alcohols having 1 to 12 C atoms and subsequent partial transesterification of the triglyceride derivatives to form alkyl ester polyols with 1 to 12 C atoms in the alkyl group.

The polyether polyols suitable as polyol component ii) are known from polyurethane chemistry. They are typically obtained starting from low molecular weight, polyfunctional, OH— or NH-functional compounds as starters by reaction with cyclic ethers or mixtures of different cyclic ethers. Bases, such as KOH or double metal cyanide-based systems are used as catalysts in these reactions. Production processes suitable for this purpose are disclosed e.g. in U.S. Pat. No. 6,486,361 or L. E. St. Pierre, Polyethers Part I, Polyalkylene Oxide and other Polyethers, editor: Norman G. Gaylord; High Polymers Vol. XIII; Interscience Publishers; Newark 1963; p. 130 ff.

Suitable starters preferably have 2 to 8, more preferably 2 to 6, hydrogen atoms capable of polyaddition with cyclic ethers. Such compounds include water, ethylene glycol, 1,2- or 1,3-propylene glycol, 1,3-butanediol, 1,4-butanediol, 1,6hexanediol, bisphenol A, neopentyl glycol, glycerol, trimethylolpropane, pentaerythritol or sorbitol.

Alkylene oxides, such as ethylene oxide, propylene oxide, butylene oxide, epichlorohydrin, styrene oxide or tetrahydrofuran are suitable as cyclic ethers. In component ii), polyethers based on the above-mentioned starters with propylene oxide, ethylene oxide and/or tetrahydrofuran units are preferably used, more preferably with propylene oxide and/or ethylene oxide units.

The polyether polyols suitable as polyol component ii) have number average molecular weights of between about 200 and 20 000 g/mol, preferably between about 500 and 12 000 g/mol and more preferably between about 1000 and about 8000 g/mol.

The polycarbonate polyols, which are suitable for use as polyol component ii), are substantially linear and possess at least two, preferably terminal, OH groups. They can be obtained by the reaction of diols (such as propylene glycol, 1,4-butanediol or 1,6-hexanediol, diethylene glycol, triethylene glycol or tetraethylene glycol or mixtures thereof) with diaryl carbonates (such as diphenyl carbonate or phosgene).

The ratio of components i) and ii) to one another is selected to obtain equivalent ratio of NCO groups to OH groups of 1.2 to 4.0, preferably of 1.4 to 3.0.

The reaction of components i) and ii) to prepare polyurethane prepolymers A) takes place such that the polyols, which are liquid at reaction temperatures, are blended with an excess of the polyisocyanates and the homogeneous mixture is stirred until a constant NCO content is obtained. The reaction temperature is 40° C. to 180° C., preferably 50° C. to 140° C. The production of the polyurethane prepolymers A) can naturally also take place continuously in a stirred vessel cascade or suitable mixers, such as high-speed-mixers according to the rotor-stator principle.

It is also possible to modify the polyester and/or polyether and/or polycarbonate polyols or a part thereof with a deficiency of diisocyanates, preferably 1,6-diisocyanatohexane (HDI), 1-isocyanato-3,3,5-trimethyl-5-isocyanatomethyl-cyclohexane (isophorone diisocyanate, IPDI), 4,4′-diisocyanatodicyclohexyl-methane, 2,4- and/or 2,6-diisocyanatotoluene (TDI) and/or 2,4′- and/or 4,4′-diisocyanatodiphenylmethane (MDI), and to react the urethane group-containing polyol with an excess of diisocyanates on completion of the reaction to form polyurethane prepolymer (A). If desired, catalysts to accelerate the NCO/OH reaction and/or solvents can optionally also be added during the reaction of components i) and ii).

The amine or organometallic compounds known from polyurethane chemistry are suitable as catalysts. Suitable amine catalysts include tertiary amines such as triethylamine, dimethylbenzylamine, N,N,N′,N′-tetramethyldiaminodiethyl ether, 1,8-diazabicyclo-5,4,0-undecene-7 (DBU) and N,N′-dimorpholinodiethyl ether (DMDEE); and alkanolamine compounds such as triethanolamine, triisopropanol-amine, N-methyl- and N-ethyldiethanolamine and dimethylaminoethanol.

Also suitable are organometallic compounds of tin, lead, iron, titanium, bismuth or zirconium, such as iron(II) chloride, zinc chloride, lead octoate and preferably tin salts, such as tin dioctoate, tin(II) acetate, ethylhexoate and diethylhexoate, dibutyltin dilaurate, dibutyl dilauryltin mercaptide and dialkyltin(IV) carboxylates. Tin oxides and sulfides, as well as tin thiolates, can also be used. Specific compounds include bis(tributyltin) oxide, bis(trioctyltin) oxide, dibutyl- and dioctyltin bis(2-ethylhexylthiolate), and dibutyl- and dioctyltin didodecyl-thiolate. Ti compounds, particularly Ti(IV)-O-alkyl compounds are also suitable. Suitable alkyl groups include methyl, ethyl, n-propyl, isopropyl, n-butyl, isobutyl, tert.-butyl, n-pentyl, 2-pentyl and 3-pentyl; preferably ethyl, n-propyl, isopropyl, n-butyl, isobutyl and tert.-butyl. Especially preferred is Ti(IV) butylate. As organobismuth compounds, bismuth carboxylates are particularly used in which the carboxylic acids having 2 to 20 C atoms, preferably 4 to 14 C atoms.

If catalysts are used, they are used in a quantity of 0.01 to 8 wt. %, preferably 0.1 to 5 wt. %, based on the total quantity of components i) and ii). Starting compounds iii) for the production of blocked polyurethane prepolymers A) are CH-acidic cyclic ketones corresponding to formula (I), 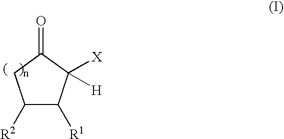
wherein
X represents an electron-attracting group,
R¹ and R² independently of one another represent the radicals H, C₁-C₂₀ (cyclo)alkyl, C₆-C₂₄ aryl, C₁-C₂₀ (cyclo)alkyl ester or amide, C₆-C₂₄ aryl ester or amide, mixed aliphatic/aromatic radicals with 1 to 24 carbon atoms which can also be part of a 4- to 8-membered ring, and
n is an integer from 0 to 5.

The electron-attracting group X in formula (1) can be any substituent that leads to a CH acidity of the α-position hydrogen. Examples include ester groups, amide groups, sulfoxide groups, sulfone groups, nitro groups, phosphonate groups, nitrile groups, isonitrile groups, carbonyl groups, polyhaloalkyl groups and halogens, particularly fluorine and chlorine. Nitrile and ester groups are preferred and the carboxylic acid methyl ester and carboxylic acid ethyl ester group are particularly preferred.

Suitable starting compounds iii) are also compounds similar to formula (I), wherein the ring optionally contains heteroatoms, such as oxygen, sulfur or nitrogen atoms. Should a heteroatom be present in the ring, the preferred structural element is that of a lactone or thiolactone.

The activated cyclic ketone of formula (1) preferably has a ring size of 5 (n=1) or 6 (n=2), n is preferably 1 to 2.

Preferred starting compounds iii) are cyclopentanone-2-carboxymethyl ester and -carboxyethyl ester, cyclopentanone-2-carboxylic acid nitrile, cyclohexanone-2-carboxymethyl ester and -carboxyethyl ester or cyclopentanone-2-carbonylmethyl. Particularly preferred are cyclopentanone-2-carboxymethyl ester and -carboxyethyl ester as well as cyclohexanone-2-carboxymethyl ester and -carboxyethyl ester. The cyclopentanone systems are readily obtained industrially by a Dieckmann condensation of dimethyl adipate or diethyl adipate. Cyclohexanone-2-carboxymethyl ester can be produced by the hydrogenation of methyl salicylate.

The blocking of the polyurethane prepolymers, which are produced by reacting components i) and ii), using cyclic ketones iii) generally takes place in the presence of a catalyst. 0.8 to 1.2 moles of the cyclic ketone iii) are used per equivalent of isocyanate groups present in the polyurethane prepolymer. Preferably, one equivalent of isocyanate groups from the polyurethane prepolymer to be blocked is reacted with one equivalent of blocking agent.

Suitable catalysts for accelerating the blocking reaction include alkali metal and alkaline earth metal bases, such as powdered sodium carbonate (soda). Depending upon the cyclic ketone iii) used, trisodium phosphate or amine bases such as Dabco® (1,4-diazabicyclo[2.2.2]octane) can also be used. The carbonates of the metals of the second subgroup of the Periodic Table are also suitable. Sodium carbonate or potassium carbonate is preferably used. Alternatively, the reaction of the cyclic ketone iii) with the NCO group-containing polyurethane prepolymer can also be performed in the presence of zinc salts as catalysts. The reaction with zinc-2-ethyl hexanoate is particularly preferred. Mixtures of catalysts can also be used.

The catalysts are generally used in a quantity of 0.01 to 10 wt. %, preferably 0.05 to 3 wt. % and more preferably 0.07 to 1 wt. %, based on the weight of the NCO terminated prepolymer.

The reaction can be performed at 0° C. to 140° C. A temperature range of 15° C. to 90° C. is preferred.

The blocking can take place in the absence or in the presence of suitable solvents, which include the known paint solvents, such as butyl acetate, methoxypropyl acetate, methyl ethyl ketone, acetone, N-methyl-2-pyrrolidone, toluene, xylene, solvent naphtha, as supplied e.g. by Exxon Chemie as an aromatic-containing solvent (Solvesso 100®), and mixtures of the above solvents.

In addition to cyclic ketones iii), other known blocking agents can also be used for the production of the blocked prepolymers A). The amount of cyclic ketones iii) is at least 30 wt. %, preferably 50 wt. % and more preferably 100 wt. %, based on the weight of the blocking agent. Suitable additional blocking agents include diisopropylamine, diethyl malonate, acetoacetic ester, acetone oxime, butanone oxime, ε-caprolactam, 3,5-dimethylpyrazole, 1,2,4-triazole, dimethyl-1,2,4-triazole, imidazole or mixtures of these blocking agents.

The blocked polyurethane prepolymers A) obtained by this method generally have a content of blocked isocyanate groups (calculated as NCO) of 0.1 to 20 wt. %, preferably 0.1 to 15.6 wt. % and more preferably of 0.1 to 14 wt. %, based on the weight of the blocked prepolymer. They are outstandingly suitable as starting components for the production of the reactive compositions according to the invention.

The OH-functional compounds of component B) are polyols in which the OH groups undergo activation by β-position amine components. These mixed functional reactants include ethanolamine, methylethanolamine, dimethylethanolamine, diethanolamine, methyldiethanolamine or polyfunctional aminoethanols. A preferred mixed-functional reactant is N,N,N′,N′-tetrakis(2-hydroxyethyl)ethylenediamine or N,N-bis(2-hydroxyethyl)amine.

To produce the reactive compositions according to the invention, blocked polyurethane prepolymers A) are combined with OH-functional reactants B) in quantities such that 0.6 to 1.4, preferably 0.8 to 1.2 and more preferably 0.9 to 1.1 isocyanate-reactive groups are present for every blocked and optionally free isocyanate group.

The resulting reactive compositions may optionally contain suitable catalysts C), which make crosslinking possible at temperatures as low as room temperature or accelerate it with the supply of heat.

Suitable catalysts C) include dibutyltin dilaurate (DBTL), titanium-2-ethylhexanoate, titanium tetraisopropylate and other common titanium(IV) compounds, zirconium-2-ethylhexanoate and other common zirconium(IV) compounds, aluminium triethylate, scandium trifluoromethanesulfonate, yttrium-2-ethylhexanoate, yttrium trifluoromethanesulfonate, lanthanum-2-ethylhexanoate, lanthanum trifluoromethanesulfonate, cobalt-2-ethylhexanoate, copper-2-ethylhexanoate, indium trifluoromethanesulfonate, gallium acetylacetonate, nickel acetylacetonate, lithium-2-ethylhexanoate, lithium trifluoromethanesulfonate, sodium-2-ethylhexanoate, sodium acetate, sodium trifluoromethanesulfonate, magnesium-2-ethylhexanoate, magnesium trifluoromethanesulfonate, calcium-2-ethylhexanoate, calcium trifluoromethanesulfonate, zinc-2-ethylhexanoate, zinc dithiocarbamate, zinc acetylacetonate, zinc tetramethylheptadionate, zinc salicylate, zinc chloride and other common zinc(II) compounds, bismuth-2-ethylhexanoate and bismuth acetate.

Preferred catalysts C) are zinc and bismuth compounds; zinc-2-ethylhexanoate and bismuth-2-ethylhexanoate are particularly preferred.

The catalysts are generally used in a quantity of 0.00001 to 2.0, preferably 0.05 to 1.0 and more preferably 0.01 to 0.7%, based on weight of the reactive composition.

The reactive compositions can also contain additives D) known from adhesives technology as formulation additives. Such additives are include plasticizers, fillers, pigments, drying agents, light stabilizers, antioxidants, thixotropic agents and adhesion promoters. Carbon black, precipitated silicas, pyrogenic silicas, mineral chalks and precipitated chalks are examples of suitable fillers. Suitable plasticizers include phthalic acid esters, adipic acid esters, alkylsulfonic acid esters of phenol or phosphoric acid esters. Pyrogenic silicas, polyamides, hydrogenated castor oil derivatives or polyvinyl chloride are examples of thixotropic agents.

Suitable drying agents include, in particular, alkoxysilyl compounds such as vinyltrimethoxysilane, methyltrimethoxysilane, i-butyltrimethoxysilane and hexadecyltrimethoxysilane; inorganic substances such as calcium oxide (CaO); and compounds having isocyanate groups such as tosyl isocyanate. The known functional silanes such as the preceding aminosilanes and also N-aminoethyl-3-aminopropyltrimethoxy and/or N-aminoethyl-3-aminopropylmethyldimethoxy-silane, epoxysilanes and/or mercaptosilanes may be used as adhesion promoters.

The production of the reactive compositions according to the invention from components A) and B) and optionally C) and/or D) preferably takes place at temperatures of −20° C. to 50° C. and more preferably at temperatures of 0° C. to 40° C.

The reactive compositions according to the invention can be used for the production of adhesives, sealants, coatings, embedding compounds or moldings. The use of the reactive compositions according to the invention for the production of adhesives is preferred.

The reactive compositions according to the invention are suitable for bonding a wide variety of materials to themselves or to one another, such as metal, plastic, glass, wood, leather and textiles.

The present invention also provides a process for the production of composite systems, wherein the adherends to be bonded are coated either on one side or on both sides with the reactive compositions according to the invention.

The present invention also provides composite systems containing the reactive compositions according to the invention as coatings.

Depending upon the composition of the reactive compositions according to the invention selected, they may be cured under ambient conditions, i.e. at temperatures of preferably −30° C. to 50° C. and a relative humidity of preferably 10% to 90%, within hours to several days. By increasing the temperature to above 50° C., preferably at temperatures of approx. 60° C. to approx. 100° C. and more preferably at temperatures of about 60° C. to about 80° C., the curing can additionally be accelerated, which may be desirable in practice. In this case, the reactive compositions according to the invention cure within a few minutes to several hours, depending upon the composition selected.

The invention is explained by means of the following examples:

### EXAMPLES

In the following examples, percentages are by weight. The viscosities were determined at a test temperature of 23° C. using a ViscoTester VT 550 rotational viscometer from Thermo Haake, Karlsruhe, DE with the SV measuring cup and the SV DIN 2 sensor.

The NCO content of the prepolymers and reaction mixtures was determined in accordance with DIN EN 1242.

Starting Compounds

Cyclopentanone-2-carboxyethyl ester (obtained from Fluka). N,N,N′,N′-Tetrakis(2-hydroxyethyl)ethylenediamine (obtained from Fluka and used without any further purification).

Production of Polyurethane Prepolymers Blocked with α-Acidic Cyclic Ketones

Blocked Polyurethane Prepolymer A:

In a nitrogen atmosphere, 100.8 g (0.30 equiv) of an NCO prepolymer prepared from HDI and a polyether diol (Desmodur® E 305; Bayer MaterialScience AG, Leverkusen, NCO content 12.5%, equivalent weight 336 g/equiv) and 0.095 g of zinc-2-ethylhexanoate were initially charged into a 250 ml four-necked flask with a reflux condenser and internal thermometer. 47.8 g (0.306 equiv) of cyclopentanone-2-carboxyethyl ester were then added slowly, dropwise, at room temperature so that the reaction temperature did not exceed 40° C. A water bath was available to cool the mixture, if necessary. When all of the ester had been added, stirring was continued at 40° C. until the NCO content of the reaction mixture reached zero. The blocked NCO content of the prepolymer was 8.52%.

Blocked Polyurethane Prepolymer B:

In a nitrogen atmosphere, 146.2 g (0.15 equiv) of an NCO prepolymer prepared from diisocyanatotoluene (TDI) and a polyether diol (Desmodur® E 15; Bayer MaterialScience AG, Leverkusen, NCO content 4.3%, equivalent weight 974.5 g/equiv) and 0.170 g of zinc-2-ethylhexanoate were initially charged into a 250 ml four-necked flask with a reflux condenser and internal thermometer. 23.4 g (0.15 equiv) of cyclopentanone-2-carboxyethyl ester were then added slowly, dropwise, at room temperature so that the reaction temperature did not exceed 40° C. A water bath was available to cool the mixture, if necessary. When all of the ester had been added, stirring was continued at 40° C. until the NCO content of the reaction reached zero. The blocked NCO content of the prepolymer was 3.71% and the viscosity was 48,900 mPas.

Blocked Polyurethane Prepolymer C:

1.2 equiv of 2,6-diisocyanatotoluene (TDI) and 348.1 g of acetone were initially charged into a 500 ml three-necked flask at a temperature of 50° C. 150 g of a polyester diol (Baycoll® AD 1225; Bayer MaterialScience AG, Leverkusen, hydroxyl value 225 mg KOH/g substance, corresponding to a hydroxyl content of 6.52 to 7.12%) were then added. The temperature was maintained so that it did not exceed 60° C. The mixture was allowed to react until the NCO content for the urethane stage was reached (4.18%). It was then cooled to 45° C. 93.7 g (0.6 equiv) of cyclopentanone-2-carboxyethyl ester and 348 mg zinc-2-ethylhexanoate were added. The mixture was allowed to react at 45 to 50° C. until an NCO content of zero was reached. The acetone was then distilled off. The resulting product had a blocked NCO content of 14.5%. The substance was solid.

Blocked Polyurethane Prepolymer D:

In a nitrogen atmosphere at a temperature of 60° C., 193.93 g (2.23 equiv) of 2,6-diisocyanatotoluene (TDI) were initially charged into a 2000 ml four-necked flask with a stirrer, reflux condenser and internal thermometer. 1114.56 g (1.11 equiv) of a polypropylene glycol (Acclaim® 2200; Bayer MaterialScience AG, Leverkusen, DE, hydroxyl value of approx. 56 mg KOH/g, nominal functionality of 2) were then added slowly, through a dropping funnel, so that the temperature did not exceed 60° C. during this addition. When all of the polyether had been added, stirring was continued at 60° C. until the NCO content for the urethane stage was reached (3.58%). The mixture was allowed to cool to 50° C. and a quantity of 1.5 g zinc-2-ethylhexanoate was stirred in. 191.5 g (1.23 equiv) of cyclopentanone-2-carboxyethyl ester were then added dropwise over a period of 30 minutes. The reaction was allowed to continue until an NCO content of zero was reached (approx. 10 hours). The mixture was then cooled to room temperature and the product was poured off. The blocked NCO content of the prepolymer was 3.12%.

Blocked Polyurethane Prepolymer E:

In a nitrogen atmosphere at a temperature of 60° C., 111.26 g (1.28 equiv) of 2,6-diisocyanatotoluene (TDI) were initially charged into a 2000 ml four-necked flask with a stirrer, reflux condenser and internal thermometer. 1278.87 g (0.64 equiv) of a polypropylene glycol (Acclaim® 4200; Bayer MaterialScience AG, Leverkusen, DE, hydroxyl value of approx. 28 mg KOH/g, nominal functionality of 2) were then added slowly, through a dropping funnel, so that the temperature did not exceed 60° C. during this addition. When all of the polyether had been added, stirring was continued at 60° C. until the NCO content for the urethane stage was reached (1.93%). The mixture was allowed to cool to 50° C. and a quantity of 0.5 g of zinc-2-ethylhexanoate was stirred in. 109.87 g (0.7 equiv) of cyclopentanone-2-carboxyethyl ester were then added dropwise over a period of 30 minutes. The reaction was allowed to continue until an NCO content of zero was reached (approx. 10 hours). The mixture was then cooled to room temperature and the product was poured off. The blocked NCO content of the prepolymer was 1.79%.

### Application Examples

### Example 1

The quantity of the blocked polyurethane prepolymer (component A) set forth in Table 1 was mixed intensively with the quantity of N,N,N′,N′-tetrakis(2-hydroxyethyl)ethylenediamine (component B) set forth in the table, corresponding to a ratio of blocked NCO groups to OH groups of 1:1. The mixture was then poured into a Teflon dish (diameter: 8 cm, depth: 1 cm) and allowed to cure at room temperature. The measured times to complete cure are set forth in Table 1.

### Comparison Example 1

The quantity of the blocked polyurethane prepolymer (component A) set forth in Table 2 was mixed intensively with the quantity of polyamine set forth in the table as crosslinking agent, corresponding to a ratio of blocked NCO groups to NH groups of 1:1. The mixture was then poured into a Teflon dish (diameter: 8 cm, depth: 1 cm) and allowed to cure at room temperature. The measured times to complete cure are set forth in Table 2.

### Example 2

The quantity of the blocked polyurethane prepolymer (component A) set forth in Table 3 was mixed intensively with the quantity of N,N,N′,N′-tetrakis(2-hydroxyethyl)ethylenediamine (component B) set forth in the table, corresponding to a ratio of blocked NCO groups to OH groups of 1:1. The mixture was then placed on a Kofler bench and the time to complete cure at elevated temperature determined. The measured times to complete cure are set forth in Table 3.

### Example 3

15 g of blocked polyurethane prepolymer A were weighed with 1.797 g of N,N,N′,N′-tetrakis(2-hydroxyethyl)ethylenediamine as reactant, corresponding to a ratio of blocked isocyanate groups to OH groups of 1:1. 0.15 g of zinc-2-ethylhexanoate was added as catalyst and blended by intensive stirring. Using this adhesive composition, beechwood boards (size 30×120×4.0 mm, stored at 23° C. and 50% relative humidity) were bonded with unplasticized PVC film (Benecke-Kaliko, Benelitfolie RTF, dimensions 30×210×0.4 mm). The adhesive was applied onto one side of the beechwood using a grooved doctor blade (150 μm). The adherend surface was approx. 30×90 mm. The bonded substrates were weighted with a 2 kg weight and left for 3 days to cure. The peel strength was then determined at a peel angle of 180° and a peel rate of 100 mm/min. Five individual measurements were carried out and then averaged. The peel strength was 3.7 N/mm.

### Example 4

15 g of blocked polyurethane prepolymer C were weighed with 1.526 g of N,N,N′,N′-tetrakis(2-hydroxyethyl)ethylenediamine as reactant, corresponding to a ratio of blocked isocyanate groups to OH groups of 1:1. 0.15 g of zinc-2-ethylhexanoate was added as catalyst and blended by intensive stirring. Using this adhesive composition, beechwood boards (size 30×120×4.0 mm, stored at 23° C. and 50% relative humidity) were bonded with unplasticized PVC film (Benecke-Kaliko, Benelitfolie RTF, dimensions 30×210×0.4 mm). The adhesive was applied onto one side of the beechwood using a grooved doctor blade (150 μm). The adherend surface was approx. 30×90 mm. The bonded substrates were weighted with a 2 kg weight and left for 3 days to cure. The peel strength was then determined at a peel angle of 180° and a peel rate of 100 mm/min. Five individual measurements were carried out and then averaged. In two test pieces, substrate rupture occurred (the PVC film tore). Of the three remaining individual measurements, an average value of the peel strength was 4.5 N/mm.

### Example 5

15 g of blocked polyurethane prepolymer A were weighed with 1.797 g of N,N,N′,N′-tetrakis(2-hydroxyethyl)ethylenediamine as reactant, corresponding to a ratio of blocked isocyanate groups to OH groups of 1:1. 0.15 g of zinc-2-ethylhexanoate was added as catalyst and blended by intensive stirring. Using this adhesive composition, NBR test pieces (30×180 mm) were bonded to one another. The adhesive was applied onto one side using a grooved doctor blade (150 μm). The bonded substrates were weighted with a 4 kg weight and left for 3 days to cure. The peel strength was then determined at a peel angle of 180° and a peel rate of 100 mm/min. Three individual measurements were carried out and then averaged. The peel strength was 3.6 N/mm.

TABLE 1
Curing time of reactive compositions according to the
invention at room temperature (approx. 25° C.)

| | | | | Curing |
|---|---|---|---|---|
| | Quantity | | Quantity | time |
| Component A) | [g] | Component B) | [g] | [min] |
| Blocked | 15 | N,N,N′,N′-Tetrakis(2- | 1.797 | 1440 |
| polyurethane | | hydroxyethyl)ethylene- | | |
| prepolymer A | | diamine | | |
| Blocked | 15 | N,N,N′,N′-Tetrakis(2- | 0.799 | 1440 |
| polyurethane | | hydroxyethyl)ethylene- | | |
| prepolymer B | | diamine | | |
| Blocked | 15 | N,N,N′,N′-Tetrakis(2- | 0.632 | 2880 |
| polyurethane | | hydroxyethyl)ethylene- | | |
| prepolymer D | | diamine | | |
| Blocked | 15 | N,N,N′,N′-Tetrakis(2- | 0.348 | 2880 |
| polyurethane | | hydroxyethyl)ethylene- | | |
| prepolymer E | | diamine | | |

TABLE 2
Curing time of comparative examples at room temperature (approx. 25° C.)

| | Quantity | | Quantity | Curing time |
|---|---|---|---|---|
| Component A) | [g] | Polyamine | [g] | [min] |
| Blocked polyurethane | 15 | 4,4′-Diaminodicyclohexyl-methane (PACM 20) | 1.13 | 75 |
| prepolymer D | | | | |
| Blocked polyurethane | 15 | 4,4′-Diaminodicyclohexyl-methane (PACM 20) | 0.68 | 90 |
| prepolymer E | | | | |
| Blocked polyurethane | 15 | 4,4′-Diamino-3,3′-dimethyldicyclohexyl- | 1.28 | 195 |
| prepolymer D | | methane (Laromin C260) | | |
| Blocked polyurethane | 15 | 4,4′-Diamino-3,3′-dimethyldicyclohexyl- | 0.77 | 135 |
| prepolymer E | | methane (Laromin C260) | | |

TABLE 3
Curing time of reactive compositions according
to the invention at elevated temperatures

| | Quantity | | Quantity | Temperature | Curing time |
|---|---|---|---|---|---|
| Component A) | [g] | Component B) | [g] | [° C.] | [min] |
| Blocked | 10 | N,N,N′,N′- | 1.2 | 80 | 251 |
| polyurethane | | Tetrakis(2- | | 100 | 96 |
| prepolymer A) | | hydroxyethyl)- | | | |
| | | ethylenediamine | | | |
| Blocked | 10 | N,N,N′,N′- | 0.53 | 60 | 220 |
| polyurethane | | Tetrakis(2- | | 80 | 85 |
| prepolymer B | | hydroxyethyl)- | | 100 | 33 |
| | | ethylenediamine | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A reactive composition comprising
A) one or more blocked polyurethane prepolymer which has a content of blocked isocyanate groups (calculated as NCO) of 0.1 to 20 wt. % and is prepared from
i) at least one aromatic, aliphatic, araliphatic and/or cycloaliphatic diisocyanate having a content of free NCO groups of 5 to 60 wt. %,
ii) a polyol component containing at least one polyester polyol, and/or at least one polyether polyol and/or at least one polycarbonate polyol,
iii) a CH-acidic cyclic ketone corresponding to formula (I) as blocking agent 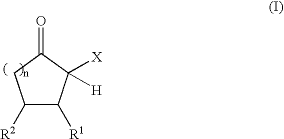
wherein
X represents an electron-attracting group,
R¹ and R² independently of one another represent the radicals H, C₁-C₂₀ (cyclo)alkyl, C₆-C₂₄ aryl, C₁-C₂₀ (cyclo)alkyl ester or amide, C₆-C₂₄ aryl ester or amide, mixed aliphatic/aromatic radicals having 1 to 24 carbon atoms that can also be part of a 4- to 8-membered ring and
n is an integer from 0 to 5, and
B) one or more OH-functional compound in which the OH component undergoes activation by a β-position amine component.

2. The reactive composition of claim 1 wherein component i) comprises 1,6-diisocyanatohexane (HDI), 1-isocyanato-3,3,5-trimethyl-5-isocyanatomethylcyclohexane (isophorone diisocyanate, IPDI), 4,4′-diisocyanato-dicyclohexylmethane, 2,4- and/or 2,6-diisocyanatotoluene (TDI), or 2,2′-, 2,4′- and/or 4,4′-diisocyanatodiphenylmethane (MDI).

3. The reactive composition of claim 1 wherein component iii) comprises cyclopentanone-2-carboxymethyl ester, cyclopentanone-2-carboxyethyl ester, cyclopentanone-2-carboxylic acid nitrile, cyclohexanone-2-carboxymethyl ester, cyclohexanone-2-carboxyethyl ester or cyclopentanone-2-carbonylmethyl.

4. The reactive composition of claim 2 wherein component iii) comprises cyclopentanone-2-carboxymethyl ester, cyclopentanone-2-carboxyethyl ester, cyclopentanone-2-carboxylic acid nitrile, cyclohexanone-2-carboxymethyl ester, cyclohexanone-2-carboxyethyl ester or cyclopentanone-2-carbonylmethyl.

5. The reactive composition of claim 1 wherein polyurethane prepolymer A) has a content of blocked isocyanate groups of 0.1 to 15.6 wt. %.

6. The reactive composition of claim 1 wherein component B) comprises ethanolamine, methylethanolamine, dimethylethanolamine, diethanolamine, methyldiethanolamine or a polyfunctional aminoethanol.

7. The reactive composition of claim 2 wherein component B) comprises ethanolamine, methylethanolamine, dimethylethanolamine, diethanolamine, methyldiethanolamine or a polyfunctional aminoethanol.

8. The reactive composition of claim 3 wherein component B) comprises ethanolamine, methylethanolamine, dimethylethanolamine, diethanolamine, methyldiethanolamine or a polyfunctional aminoethanol.

9. The reactive composition of claim 4 wherein component B) comprises ethanolamine, methylethanolamine, dimethylethanolamine, diethanolamine, methyldiethanolamine or a polyfunctional aminoethanol.

10. The reactive composition of claim 1 wherein component B) comprises N,N,N′,N′-tetrakis(2-hydroxyethyl)ethylenediamine and/or N,N-bis(2-hydroxyethyl)amine.

11. The reactive composition of claim 2 wherein component B) comprises N,N,N′,N′-tetrakis(2-hydroxyethyl)ethylenediamine and/or N,N-bis(2-hydroxyethyl)amine.

12. The reactive composition of claim 3 wherein component B) comprises N,N,N′,N′-tetrakis(2-hydroxyethyl)ethylenediamine and/or N,N-bis(2-hydroxyethyl)amine.

13. The reactive composition of claim 4 wherein component B) comprises N,N,N′,N′-tetrakis(2-hydroxyethyl)ethylenediamine and/or N,N-bis(2-hydroxyethyl)amine.

14. A process for the production of the reactive compositions according to claim 1 which comprises reacting blocked polyurethane prepolymers A) with OH-functional compound B) in an amount such that there are 0.6 to 1.4 isocyanate-reactive groups for every blocked and optionally free isocyanate group.

15. A composite system comprising two adherends bonded together with the reactive composition of claim 1.

16. The composite system of claim 15 wherein the adherends are metal, plastic, glass, wood, leather or a textile.
